(19) United States
(12) Patent Application Publication
(10) Pub. No.: US 2015/0069763 A1
(43) Pub. Date: Mar. 12, 2015

(54) LOAD COVER

(71) Applicant: General Electric Company, Schenectady, NY (US)

(72) Inventors: Len Alan Wolf, Greenville, SC (US); Joseph Michael Harvey, Greer, SC (US)

(73) Assignee: General Electric Company, Schenectady, NY (US)

(21) Appl. No.: 14/023,029

(22) Filed: Sep. 10, 2013

(51) Int. Cl. H02K 5/24; H02K 7/18; H02K 7/00

(52) U.S. Cl. CPC H02K 5/24; H02K 7/003; H02K 7/1823
USPC 290/1 R; 181/202

(57) ABSTRACT

A load cover for a coupling between a rotor of a gas turbine engine and a generator is provided. The load cover includes a guard which is disposed about the rotor and a baffle disposed around the guard to form an annulus of circumferentially increasing area. The baffle includes a scoop element at an outlet of the annulus.

### BACKGROUND OF THE INVENTION

The subject matter disclosed herein relates to a load cover enclosing a coupling between a gas turbine rotor and a generator and, more particularly, to a load cover that provides acoustic attenuation and ventilation flow and encloses a coupling between a gas turbine rotor and a generator.

In gas turbine engines, combustion gases are expanded in a turbine section disposed downstream from a combustor to produce mechanical energy. This mechanical energy causes a rotor extending through the turbine section to rotate about a longitudinal axis thereof The rotor extends through the turbine, a compressor and a generator such that the rotation of the rotor causes the compressor to compress inlet gases for use in the combustion and causes the generator to convert the rotation of the rotor to electrical power.

With the above-described configuration, a source of acoustic and ventilation issues may be the location where the rotor connects with or is coupled to the generator. In some cases, this region has a fixed duct that produces a cooling flow and has flow control features but generally lacks acoustic attenuation capability. This lack of acoustic capabilities, can lead to reduced efficiencies, performance degradation and economic costs.

### BRIEF DESCRIPTION OF THE INVENTION

According to one aspect of the invention, a load cover for a coupling between a rotor of a gas turbine engine and a generator is provided. The load cover includes a guard, which is disposed about the rotor, and a baffle disposed around the guard to form an annulus of circumferentially increasing area. The baffle includes a scoop element at an outlet of the annulus.

According to another aspect of the invention, a load cover for a coupling between a rotor of a gas turbine engine and a generator is provided and includes a tubular guard, which is disposed about the rotor, and a baffle disposed around the guard to form an annulus of circumferentially increasing area. The baffle is formed to define an inlet at a lower portion of the annulus by which fluid is permitted to enter the annulus and an outlet at an upper portion of the annulus by which the fluid is forced out of the annulus by rotor rotation. The baffle includes a scoop element at the outlet, which is configured to direct fluid egress from the annulus.

According to yet another aspect of the invention, a gas turbine engine is provided and includes a turbine section in which an expansion of combustion gases produces mechanical energy, a rotor, which extends through the turbine section, the rotor being drivable to rotate by the mechanical energy, a generator through which the rotor extends, the generator being configured to produce electricity from rotor rotation and a load cover at a coupling between the rotor and the generator. The load cover includes a guard, which is disposed about the rotor, and a baffle disposed around the guard to form an annulus of circumferentially increasing area. The baffle includes a scoop element at an outlet of the annulus.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of a gas turbine engine in accordance with embodiments;

FIG. 2 is a perspective view of a load cover in accordance with embodiments;

FIG. 3 is a side view of a load cover in accordance with embodiments;

FIG. 4 is an axial view of the load cover of FIG. 3 along the line 4-4; and

FIG. 5 is an enlarged view of the encircled portion of FIG. 4.

The detailed description explains embodiments of the invention, together with advantages and features, by way of example with reference to the drawings.

### DETAILED DESCRIPTION OF THE INVENTION

As described below, a load cover that encloses a coupling between a gas turbine rotor and a generator is provided. The load cover has acoustic and flow control features. The acoustic features limit noise generation in the load cover and the flow control features ensure a cooling flow of ambient air, which is produced by the rotation of the coupling inside the load cover.

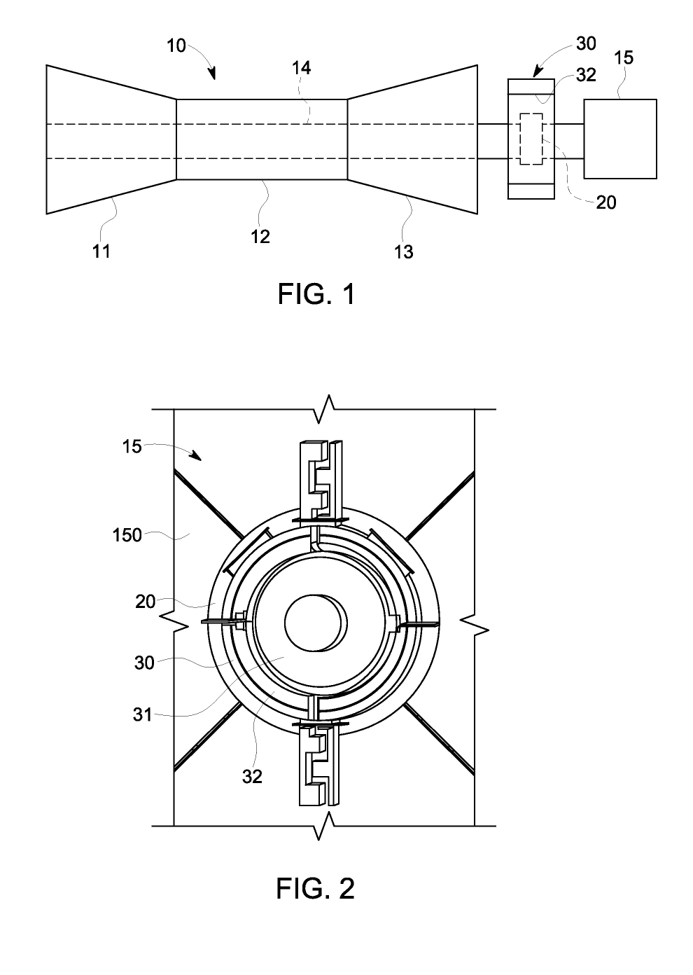

With reference to FIG. 1, a gas turbine engine 10 is provided and includes a compressor 11, a combustor 12 and a turbine section 13. The compressor 11 is configured to compress inlet air and the combustor 12 is configured to mix the compressed inlet air with fuel and to cause the mixture to combust in an interior thereof This combustion produces a high temperature and high pressure working fluid that is directed toward the turbine section 13, which is disposed downstream from the combustor 12. Inside the turbine section 13, the working fluid is expanded to produce mechanical energy and this mechanical energy causes a rotor 14, which extends through the compressor 11 and the turbine section 13, to rotate. The rotation of the rotor 14 drives an operation of the compressor 11.

With reference to FIGS. 1-4, the gas turbine engine 10 further includes a generator 15 and a coupling 20. The rotor 14 extends out of the turbine section 13 and is rotatably coupled to the generator 15 via the coupling 20 such that rotation of the rotor 14 causes the generator 15 to generate electricity for application to a load.

As shown in FIGS. 1-4, a load cover 30 is provided at the coupling 20 between the rotor 14 and the generator 15 to surround the coupling 20. The load cover 30 abuts or is disposed proximate to an axial surface 150 of the generator 15 and includes a guard 31, which is disposed about the rotor 14, and a baffle 32. The load cover 30 may further include a wall structure that has access hatches for generator 15 grounding brushes and double layers of mineral wool and vinyl loaded septum structures for acoustic attenuation.

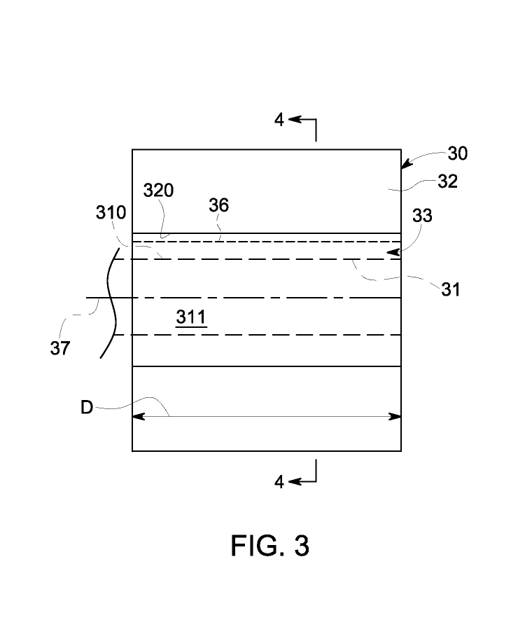

The guard 31 and the baffle 32 extend in an axial direction or axially away from the axial surface 150 by a length or distance D (see FIG. 3), which in either case defines an axial length of the load cover 30. The baffle 32 is disposed about the guard 31 to form an annulus 33 between an exterior surface 310 of the guard 31 and an interior surface 320 of the baffle 32. The baffle 32 is further formed to define an inlet 34 at a bottom portion of the annulus 33 and an outlet 35 at a top portion of the annulus 33. The baffle 32 includes a scoop element 36 at the outlet 35.

In accordance with embodiments, the guard 31 may be provided as a substantially tubular element 311 and the interior surface 320 of the baffle 32 may be curved about a central axis 37 defined axially through the load cover 30 and along the rotor 14. The curvature of the interior surface 320 has an increasing radius of curvature. The increasing radius of curvature provides the annulus 33 with a circumferentially increasing area through which fluids, such as coolant drawn from ambient air, can flow. In accordance with further embodiments, the circumferentially increasing area is measured from about a 12:00 position proximate to the outlet 35 and the top portion of the annulus 33, past a 6:00 position proximate to the inlet 34 and the bottom portion of the annulus 33 and back to the 12:00 position.

Where the fluids include the coolant drawn from ambient air, the ambient air may enter the annulus 33 via the inlet 34 and may exit the annulus 33 via the outlet 35. The rotation of the rotor 14 drives (or rather pulls) the flow of the air around the exterior surface 310 of the guard 31 and through the annulus 33. The circumferentially increasing area of the annulus 33 as provided by the increasing radius of curvature of the interior surface 320 of the baffle 32 causes the air to expand as it is driven (or pulled) through the annulus 33, which promotes the ingress of additional fluid via the inlet 34.

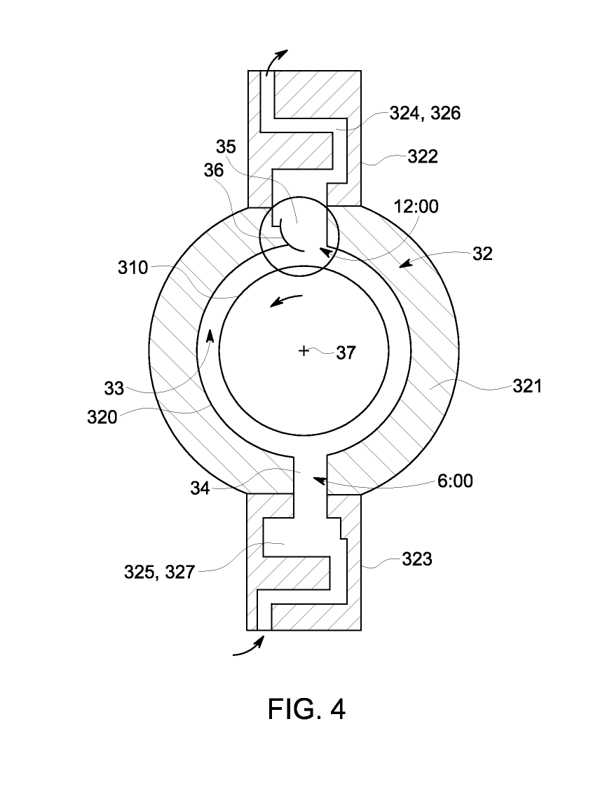

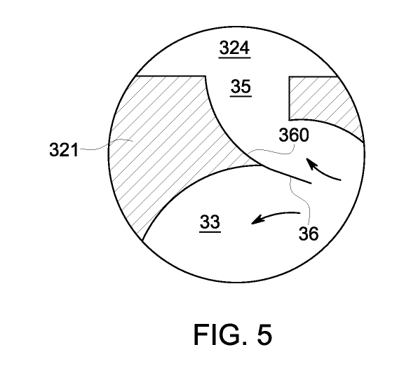

The baffle 32 is formed as a housing 321 with a top portion 322 and a lower portion 323. The top portion 322 is formed to define an outlet path 324, which is disposed in fluid communication with the outlet 35 with the outlet 35 being located at an end of the outlet path 324. The lower portion 323 is formed to define an inlet path 325, which is disposed in fluid communication with the inlet 34 with the inlet 34 being located at an end of the inlet path 325. As shown in FIG. 4, the outlet path 324 includes a serpentine outlet path 326 and the inlet path 325 includes a serpentine inlet path 327. The serpentine outlet path 236 and the serpentine inlet path 327 serve to reduce a pressure of the air in the baffle 32 and to reduce noise associated with the flow of the air through the baffle 32. In this way, at least one or both of the serpentine outlet path 236 and the serpentine inlet path 327 may act as a silencer for the load cover 30.

The scoop element 36 extends axially along the guard 31 and includes a curved surface 360. The curved surface 360 facilitates the flow of air from the end of the annulus 33, through the outlet 35 and into the outlet path 324. That is, the scoop element 36 is configured to direct fluid egress from the annulus 33. To this end, the scoop element 36 may extend into the annulus 33 in a curved or straight configuration. Where the scoop element 36 is curved, the curvature may be oriented in an opposite direction from the curvature of the interior surface 320 of the baffle 32. In accordance with embodiments, a radius of curvature of the curved scoop element 36 may be about 50 mm although this is certainly not required and should not be interpreted as limiting a scope of this disclosure in any way.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A load cover for a coupling between a rotor of a gas turbine engine and a generator, the load cover comprising:
a guard, which is disposed about the rotor; and
a baffle disposed around the guard to form an annulus of circumferentially increasing area,
the baffle comprising a scoop element at an outlet of the annulus.

2. The load cover according to claim 1, wherein the guard comprises a tubular element.

3. The load cover according to claim 1, wherein an interior surface of the baffle is curved about a central axis and has an increasing radius of curvature.

4. The load cover according to claim 1, wherein the baffle is formed to define the outlet at a top portion of the annulus and to define an inlet at a lower portion of the annulus.

5. The load cover according to claim 4, wherein the baffle comprises:
a top portion formed to define an outlet path disposed in communication with the outlet; and
a lower portion formed to define an inlet path disposed in communication with the inlet.

6. The load cover according to claim 5, wherein the outlet and inlet paths comprise serpentine paths.

7. The load cover according to claim 1, wherein the scoop element extends axially along the guard.

8. The load cover according to claim 1, wherein the scoop element comprises a curved surface that curves in an opposite direction from a curved surface of the baffle.

9. A load cover for a coupling between a rotor of a gas turbine engine and a generator, the load cover comprising:
a tubular guard, which is disposed about the rotor; and
a baffle disposed around the guard to form an annulus of circumferentially increasing area,
the baffle being formed to define an inlet at a lower portion of the annulus by which fluid is permitted to enter the annulus and an outlet at an upper portion of the annulus by which the fluid is forced out of the annulus by rotor rotation,
the baffle comprising a scoop element at the outlet, which is configured to direct fluid egress from the annulus.

10. The load cover according to claim 9, wherein the baffle comprises:
a top portion formed to define an outlet path disposed in communication with the outlet; and
a lower portion formed to define an inlet path disposed in communication with the inlet.

11. The load cover according to claim 10, wherein the outlet and inlet paths comprise serpentine paths.

12. The load cover according to claim 9, wherein the scoop element extends axially along the guard.

13. A gas turbine engine, comprising:
a turbine section in which an expansion of combustion gases produces mechanical energy;
a rotor, which extends through the turbine section, the rotor being drivable to rotate by the mechanical energy;
a generator through which the rotor extends, the generator being configured to produce electricity from rotor rotation; and
a load cover at a coupling between the rotor and the generator, the load cover comprising a guard, which is disposed about the rotor, and a baffle disposed around the guard to form an annulus of circumferentially increasing area, the baffle comprising a scoop element at an outlet of the annulus.

14. The gas turbine engine according to claim 13, wherein the guard comprises a tubular element.

15. The gas turbine engine according to claim 13, wherein an interior surface of the baffle is curved about a central axis and has an increasing radius of curvature.

16. The gas turbine engine according to claim 13, wherein the baffle is formed to define the outlet at a top portion of the annulus and to define an inlet at a lower portion of the annulus.

17. The gas turbine engine according to claim 16, wherein the baffle comprises:
a top portion formed to define an outlet path disposed in communication with the outlet; and
a lower portion formed to define an inlet path disposed in communication with the inlet.

18. The gas turbine engine according to claim 17, wherein the outlet and inlet paths comprise serpentine paths.

19. The gas turbine engine according to claim 13, wherein the scoop element extends axially along the guard.

20. The gas turbine engine according to claim 13, wherein the scoop element comprises a curved surface that curves in an opposite direction from a curved surface of the baffle.
